(19) United States
(12) Patent Application Publication
(10) Pub. No.: US 2008/0263185 A1
(43) Pub. Date: Oct. 23, 2008

(54) AUTOMATIC CONFIGURATION OF THE NETWORK DEVICES VIA CONNECTION TO SPECIFIC SWITCH PORTS

(75) Inventors: James William ANDERSON, Cambridge, MA (US); Allan Daisley, Durham, NC (US); Gregory Brian Pruett, Raleigh, NC (US); Elena Schneider, Austin, TX (US); Ethan Joshua Sommer, Durham, NC (US)

Correspondence Address: IBM RP-RPS;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/123,361

(22) Filed: May 19, 2008

Related U.S. Application Data
(63) Continuation of application No. 10/718,343, filed on Nov. 20, 2003.

(51) Int. Cl. G06F 15/177

(52) U.S. Cl. 709/220

(57) ABSTRACT

A method and system for automatically configuring devices in a network is disclosed. A network management software application is provided that enables a user to associate policy settings with physical locations in the network. During an operational mode of the network management application, the application automatically detects when a network device is plugged into the network, and determines a location of the device in the network. The device is then automatically configured based on the policy settings associated with the corresponding location.

### CROSS-REFERENCE TO RELATED APPLICATIONS

Under 35 USC §120, this application is a continuation application and claims the benefit of priority to co-pending U.S. patent application Ser. No. 10/718,343 filed entitled “Automatic Configuration of the Network Devices via Connection to Specific Switch Ports”, filed on Nov. 20, 2003, all of which is herein incorporated by reference.

### FIELD OF THE INVENTION

The present invention relates generally to computer networking, and more particularly to a method for automatically configuring the network devices upon physical connection to network.

### BACKGROUND OF THE INVENTION

Computer networks are increasingly becoming larger and denser, requiring large numbers of complex network devices. Each network device added to the network must be configured. A “configuration” is defined as a particular setting of device parameters that govern the operational characteristics of a network device. For example, devices that are routinely configured include routers and switches and examples of device parameters include individual IP addresses for the configuration ports, port thresholds, on/off switches, access security, etc.

In the prior art, one method of network configuration is to manually configure each network device. This is typically accomplished by a network administrator making a point-to-point connection with the device, e.g., physically attaching a terminal to the network device and issuing configuration commands through the terminal's keyboard. This process can quickly become tedious and inefficient in network environments where many of the settings are identical across ports and devices, or where the network configuration changes frequently.

An example of such an environment is a dense network of computer servers, referred to herein as blades. The assignee of the present invention has developed a device, called a server blade, which includes a single chassis that has built-in network connections for multiple processor blades and one or more switches. Each processor blade is installed into a slot in the chassis, and pin-out connections on the back of the blade connect to a midplane in the chassis. The slot where each blade is inserted implies the port on the network switch module that the blade will be connected to via the midplane.

Multiple server blades can network together via routers and switches. Additional processor blades can then be added to the network by insertion into an existing server blade that is connected to the network. Prior to new processor blades being deployed, however, each processor blade must be configured. For example, a newly added processor blade may require that an operating system and application be loaded onto the blade to make it functional. Because many of the functions of the processor blades are the same, it would be desirable to have a method for automatically detecting and configuring such devices when they are physically plugged into the network. The present invention addresses such a need.

### SUMMARY OF THE INVENTION

The present invention provides a method and system for automatically configuring devices in a network using a network management software application. The application first enables a user to associate policy settings with physical locations in the network. During an operation mode of the network management application, the application automatically detects when a network device is plugged into the network, and determines the location of the device in the network. The device is then automatically configured based on the policy settings associated with the corresponding location, such as downloading and installing an operating system and application program to the device.

According to the method and system disclosed herein, the network management application enables a network administrator to specify configuration policies based on physical network connections. Thus, the placement of a device in the network topology controls what settings are deployed to the new device. The configuration of newly added devices is done automatically without manual intervention, thereby enabling an enterprise to rapidly expand the size of their network infrastructure easily and efficiently.

### BRIEF DESCRIPTION OF THE DRAWINGS

FIG. 1 a block diagram illustrating an automatic network configuration system in accordance with a preferred embodiment of the present invention.

FIG. 2 is a front, top and right side exploded perspective view of a server blade system for use with the present invention.

FIG. 3 is a rear, top and left side perspective view of the rear portion of the server blade system.

FIG. 4 is a block diagram of the switch module and processor blade interconnection.

FIG. 5 is a flow diagram of the process performed by the network management software for detecting and configuring new devices connected to the network in a preferred embodiment of the present invention.

### DETAILED DESCRIPTION

The present invention relates to automatic network configuration. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

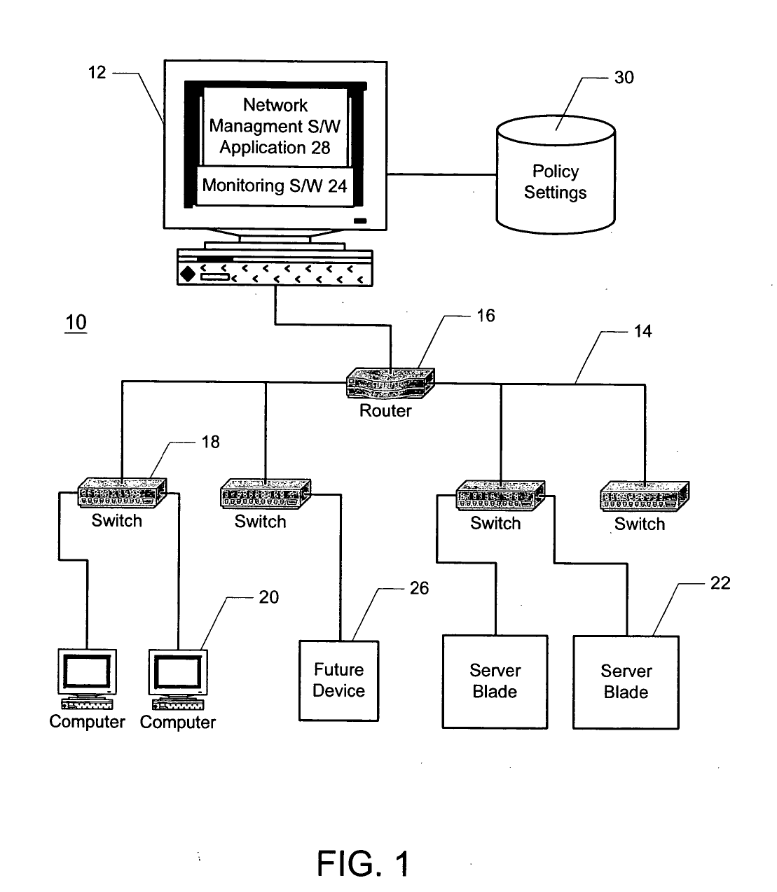

FIG. 1 a block diagram illustrating an automatic network configuration system in accordance with a preferred embodiment of the present invention. The system 10 includes a network management computer 12 that is connected to a network 14. The network 14 may be a local area network (LAN) or a wide area network (WAN), and supports the connection of a plurality of physical devices. Examples of physical devices that may be connected to the network 14 include routers 16, switches 18 and computers 20. Each physical device connected to the network 14 is connected at a node and each node is separately addressable according to whichever network protocol is implemented. The network 14 may utilize either standard Ethernet protocol or fibre channel protocol. As well known in the art, fibre channel is an industry standard networking scheme for sharing remote storage devices among groups of servers. Accordingly, the network 14 also includes server blades 22.

The network management computer 12 forms a node on the network 14. The network management computer 12 may be a standard personal computer or workstation running a standard operating system, such as Windows NT or Linux. The network management computer 12 executes network applications, such as monitoring software 24. The monitoring software 24 may implement the remote monitoring extensions of the simple network management protocol (SNMP) that provides comprehensive network monitoring capabilities.

During operation of the network 14, future devices 26 may be added at anytime by being physically plugged into a port on either a router 16 or a switch 18. In order for the future devices 26 to be deployed on the network 14, however, the devices 26 must first be configured.

Rather than requiring that the configuration be done manually by a network administrator, the present invention provides a network management software application 28 that automatically detects and configures new network devices 26 once the devices 26 are plugged into the network 14. During execution of the application 28 on the network management computer 12 (or other network device), the network management application 28 automatically detects when a new device 26 is plugged into a port on the network router 16 or switch 18. Based on the port that the device 26 is plugged into, the network management application 28 automatically configures the device 26 based on a set of preconfigured policy settings 30.

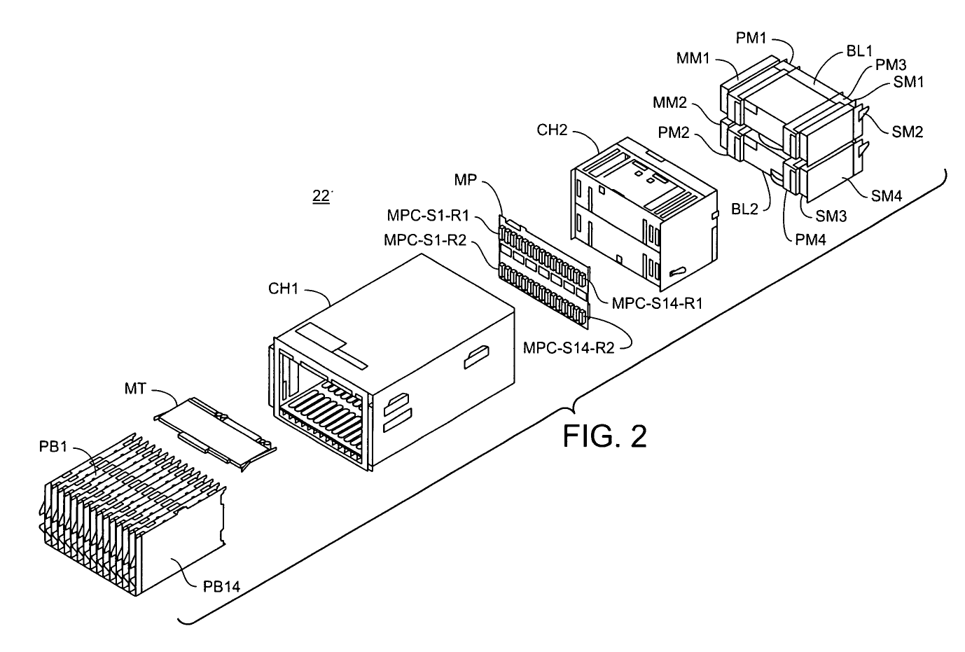

For example, to configure a newly added switch 18 on a particular port, the policy settings 30 may specify particular actions or scripts to be executed which can configure internal switch settings, such as VLAN IDs and trunkings, for the new switch. As another example, to configure a new computer 20 or server blade, another policy setting 30 may include instructions for downloading and installing an operating system and application software to the new computer. In a preferred embodiment, the present invention is used primarily to add server blades 22, switch modules 18 and processor blades to the network 14. Referring now to FIG. 2, a front, top and right side exploded perspective view of the server blade 22 is shown. A main chassis CH1 houses all the components of the server blade 22 system. Up to fourteen processor blades PB1 through PB14 (or other blades, such as storage blades) are hot pluggable into fourteen slots in the front of chassis CH1. The term “server blade”, “processor blade”, or simply “blade” is used throughout the specification and claims, but it should be understood that these terms are not limited to blades that only perform “processor” or “server” functions, but also include blades that perform other functions, such as storage blades, which typically include hard disk drives and whose primary function is data storage.

Processor blades provide the processor, memory, hard disk storage and firmware of an industry standard server. In addition, they include keyboard, video and mouse (“KVM”) selection via a control panel, an onboard service processor, and access to a floppy and CD-ROM drives in a media tray MT, which can be coupled to any of the fourteen blades. A daughter card is connected via an onboard PCI-X interface and is used to provide additional high-speed links to switch modules SM3 and SM4 (described below).

Blades may be ‘hot swapped’ without affecting the operation of other blades in the system. A processor blade is typically implemented as a single slot card (394.2 mm×226.99 mm); however, in some cases a single processor blade may require two slots.

Processor Blades interface with other components in the server blade 22 through a midplane MP through the following midplane interfaces: 1) Gigabit Ethernet (2 per blade; required); 2) Fibre Channel (2 per blade; optional); 3) management module serial link; 4) VGA analog video link; 4) keyboard/mouse USB link; 5) CO-ROM and floppy disk drive (“FOO”) USB link; 6) 12 VOC power; and 7) miscellaneous control signals. These interfaces provide the ability to communicate to other components in the server blade 22 such as management modules MM, switch modules SM, the CD-ROM and the FOO. These interfaces are duplicated on the midplane to provide redundancy. A processor blade typically supports booting from the media tray CDROM or FOO, the network (Fibre channel or Ethernet), or its local hard disk drive. Midplane circuit board MP is positioned approximately in the middle of chassis CH1 and includes two rows of connectors; the top row including connectors MPC-S1-R1 through MPC-S14-R1, and the bottom row including connectors MPC-S1-R2 through MPC-S14-R2. Thus, each one of the 14 slots includes one pair of midplane connectors located one above the other (e.g., connectors MPC-S1-R1 and MPC-S1-R2) and each pair of midplane connectors mates to a pair of connectors at the rear edge of each processor blade (not visible in FIG. 1).

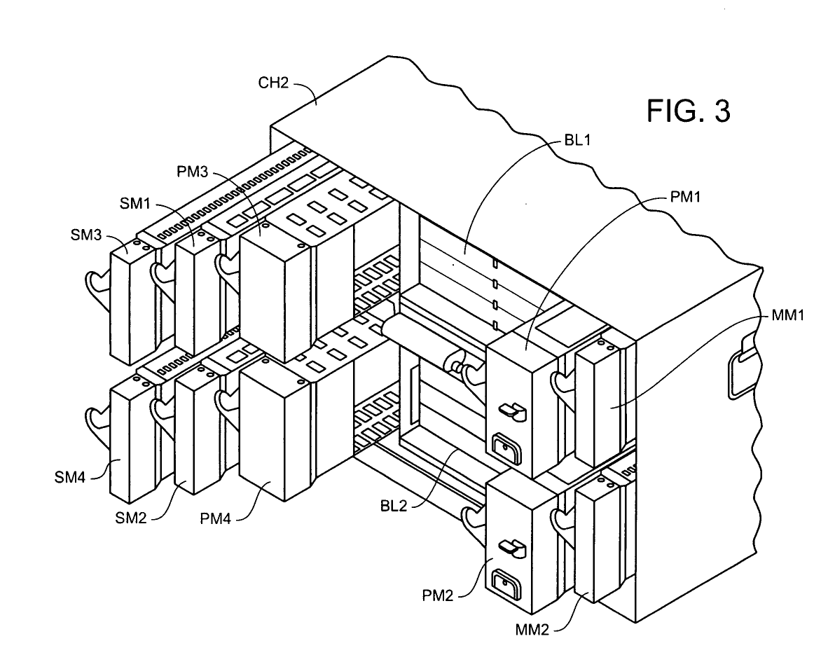

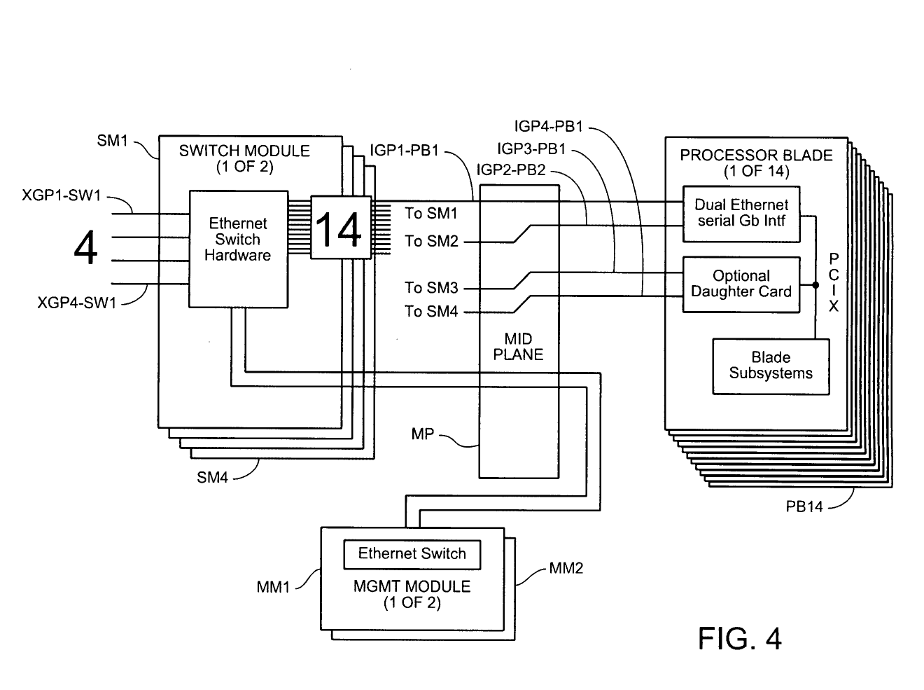

Addresses are hardwired for each slot on each top and bottom midplane connector, and used by a processor blade's service processor to determine which processor blade is being addressed on the serial bus. FIG. 3 is a rear, top and left side perspective view of the rear portion of the server blade system, and FIG. 4 is a block diagram of the switch module and processor blade interconnection. Referring to FIGS. 2, 3 and 4, the chassis CH2 slides and latches into the rear of main chassis CH1, and houses various hot pluggable components for cooling, power, control and switching. These components include two hot pluggable blowers BL1 and BL2, four hot pluggable power modules PM1 through PM4, management modules MM1-MM2, and switch modules SM1-SM4.

The Ethernet Switch Modules SW1-SW4 are hot-pluggable components that provide Ethernet switching capabilities to the server blade 22. The primary purpose of the switch module is to provide Ethernet interconnectivity between the processor blades, management modules MM1-MM2 and the outside network infrastructure. Depending on the application, the external Ethernet interfaces may be configured to meet a variety of requirements for bandwidth and function.

One Ethernet switch module is included in the base system configuration, while a second Ethernet switch module is recommended for redundancy. Each processor blade has a dedicated, 1000 Mbps (1 Gbps) full-duplex SERDES link to a specific hardwired port on each of the two switch modules, and each switch module has four external 1 Gbps (RJ45) ports for connection to the external network infrastructure.

Each switch module SW1 through SW4 includes four external gigabit ports. For example, switch module SW1 includes external gigabit ports XGP1SW1 through XGP4-SW1. Each processor blade includes four internal gigabit ports coupling the processor blade to each one of the four switch modules through the midplane connectors. For example, processor blade PB1 includes four internal gigabit ports IGP1-PB1 through IGP4-PB1. In addition, each management module is coupled to the switch module via an Ethernet link.

Each processor blade includes a connector to accept a Fibre Channel daughter board containing two Fibre Channel ports of 2 Gb each for connection to dual Fibre Channel switch modules. The routing of the Fibre Channel signals occurs through the midplane to the Fibre Channel switch modules in slots 3 and 4 in the rear of the server blade chassis. Each Fibre Channel switch module is hot-pluggable without disruption of blade or chassis operation. The routing of the two Fibre Channel ports is such that one port from each processor blade is wired to one Fibre Channel switch module, and the other port is wired to the other Fibre Channel switch module to provide redundancy. Each Fibre Channel switch module has 2 external 2 Gb ports for attachment to an external Fibre Channel switch and storage infrastructure. This option allows each of the 14 processor blades to have simultaneous access to a Fibre Channel based storage area network (SAN), as well as the Ethernet based communications network.

Management modules MM1 through MM2 are hot-pluggable components that provide basic management functions such as controlling, monitoring, alerting, restarting and diagnostics. Management modules also provide other functions required to manage shared resources, such as the ability to switch the common keyboard, video, and mouse signals among processor blades. Each of the management modules has a 100 Mbps Ethernet port that is intended to be attached to a private, secure management server. The management module firmware supports a web browser interface for either direct or remote access. Each processor blade has a dedicated service processor (SP) for sending and receiving commands to and from the management modules. A management module can also send alerts to a remote console to indicate changes in status, such as removal or addition of a blade or module. A management module also provides access to the internal management ports of the switch modules and to other major chassis subsystems (power, cooling, control panel, and media drives). The monitoring software 24 may communicate with the management module to detect the insertion of new devices, and/or may query the management module for vital product data (VPD) such as the MAC addresses or universally unique identifier (UUID) used to identify the newly inserted device.

The management software application 24 monitors the ports in the switch modules 8M of the server blade 22, as well as the ports of the switches 18 on the network to determine when new processor blades, switch modules and other devices are plugged into the network 14.

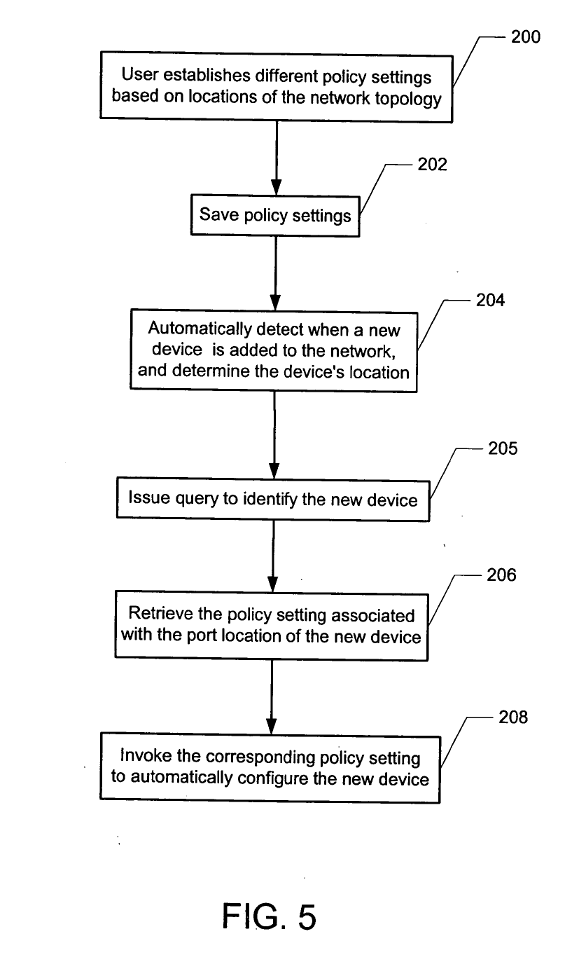

Referring now to FIG. 5, a flow diagram of the process performed by the network management software 20 for detecting and configuring new devices 26 connected to the network is shown in a preferred embodiment of the present invention. The network management application 28 enables a network administrator to specify configuration policies based on physical network connections. The network management software operates in two modes: a preconfiguration mode in which policy settings are established, and an operational mode where automatic detection and configuration of network devices is performed.

In step 200, the process typically begins with the preconfiguration mode in which the network management application 28 enables the user to establish different policy settings 30 based on locations of the network topology. In a preferred embodiment, this is accomplished by automatically displaying the configuration screen (e.g., the first time the application 28 is executed), or by displaying an icon or link that allows the user to navigate to the configuration screen. Once the configuration screen is displayed, the user creates different policy settings 30 that specify what configuration actions are to be taken, and associates each policy setting 30 with one or more physical ports on a particular network device.

After the port-specific policy settings 30 are established, in step 202, the policy settings 30 are saved in a database or file. In step 204, the network management application 28 begins executing in operational mode, automatically detects when a new device 26 is added to the network, and determines the device's location in the overall network topology. In a preferred environment, the detection and location of the device is determined by transmitting SNMP queries from the router 16 to the switches 18 that traverse the network, descending the tree of the hierarchical network topology. By transmitting the SNMP queries, the monitoring software 24 can detect newly added routers, switches, computers, and server blades. In addition, the monitoring software 24 can also detect processor blades and switch modules SM added to existing server blades 22 by communication with the Management Modules

In step 205, the network management software 28 issues queries to identify the new device. This step may involve additional queries to the connecting router 16 or switch module 18 to determine the MAC address or IP address of the newly attached device 26. In a server blade system 22, this may also involve queries to the management module to retrieve VPD data such as the UUID of the newly attached device.

In step 206, the network management software 28 retrieves the policy setting 30 associated with the port location of the new device 26 from the database or file. In step 208, the network management application 28 invokes the corresponding policy action to automatically configure the new device 26. For example, the user may establish a policy setting 30 for a particular port to configure a newly added switch. When the port is probed and a new device is detected, the corresponding policy action could automatically determine the IP address of the switch, set the username and password, and provide VLAN and trunking values, for instance. As another example, the policy action could use the MAC address retrieved in step 205 to configure a boot-up server to automatically deploy an operating system onto the newly attached computer.

A method and system for detecting and configuring new network devices has been disclosed that uses' the placement of a device in the network topology to deploy policy settings for the new device 26 as specified by the user. Such detect and deploy technology provides a key advantage: automatic network configuration without manual intervention that allows an enterprise to rapidly expand the size of their network infrastructure easily and efficiently.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1. A computer-readable medium containing program instructions for automatically configuring devices in a network, the program instructions for: associating preconfigured defined policy settings with physical locations in the network; automatically detecting when a new network device is plugged into the network and determining a location of the new network device in the network; automatically configuring the device based on the preconfigured policy settings associated with the physical location in the network.

2. The computer-readable medium of claim 1 wherein associating preconfigured policy settings with physical locations in the network further comprises displaying a configuration screen that allows the user to create different policy settings that specify what configuration actions are to be taken.

3. The computer-readable medium of claim 2 wherein associating preconfigured policy settings with physical locations in the network further comprises saving the policy settings in a database.

4. The computer-readable medium of claim 3 wherein automatically detecting when a network device is plugged into the network and determining a location of the device in the network further comprises transmitting SNMP queries to a plurality of switches that traverse the network to detect when the new network device is plugged into the network.

5. The computer-readable medium of claim 4 wherein automatically detecting when a network device is plugged into the network and determining a location of the device in the network further comprises determining which port on the network the new network device is plugged into.

6. The computer-readable medium of claim 5 wherein automatically detecting when a network device is plugged into the network and determining a location of the device in the network further comprises detecting any combination of newly added devices including routers, switches, computers, and server blades.

7. The computer-readable medium of claim 6 wherein automatically detecting when a network device is plugged into the network and determining a location of the device in the network further includes the instruction of: detecting processor blades and switches added to existing server blades.

8. The computer-readable medium of claim 1 wherein automatically configuring the new network device based on the preconfigured policy settings associated with the determined physical location further comprises retrieving from a database the preconfigured policy settings associated with the physical location of the new network device.

9. An automatic network configuration system, comprising: a network; a plurality of network devices connected to the network, including routers, switches, and computers; and a network management application executing on one of the devices for, allowing a user to establish and associate preconfigured policy settings with physical locations in the network, automatically detecting when a new network device is plugged into the network and determining a physical location of the new network device in the network, and automatically configuring the new network device based on the preconfigured policy settings associated with the physical location.

10. The system of claim 9 wherein the network management application displays a configuration screen that allows the user to create different policy settings that specifies what configuration actions are to be taken.

11. The system of claim 10 wherein the network management application saves the policy settings in a database.

12. The system of claim 11 wherein the network management application detects and locates the new network device by transmitting SNMP queries a plurality of switches that traverse the network to detect when the new network device is plugged into the network.

13. The system of claim 12 wherein the network management application determines which port on the network the new network device is plugged into.

14. The system of claim 13 wherein the network management application detects any combination of newly added devices including routers, switches, computers, and server blades.

15. The system of claim 14 wherein the network management application further detects processor blades and switches added to existing server blades.

16. The system of claim 9 wherein the network management application retrieves the preconfigured policy settings associated with the physical location of the new device from a database.
